(19) United States
(12) Patent Application Publication
(10) Pub. No.: US 2004/0001101 A1
(43) Pub. Date: Jan. 1, 2004

(54) Active window switcher

(75) Inventors: Miroslav Trajkovic, Ossining, NY (US); Vasanth Philomin, Briarcliff Manor, NY (US); Srinivas Gutta, Buchanan, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/183,797

(22) Filed: Jun. 27, 2002

(51) Int. Cl. G09G 5/00

(52) U.S. Cl. 345/781; 345/802

(57) ABSTRACT

A method for automatically switching a protected window displayed on a monitor where the monitor is connected to a processor that receives external input. The method includes the steps of: detecting a time period of inactivity of the external input; and inactivating the protected window if the time period of inactivity detected is above a predetermined threshold. The inactivating of the protected window preferably includes either minimizing the protected window, closing the protected window, or changing the protected window to a default window.

### BACKGROUND OF THE INVENTION

1. Field of the Invention

The present invention relates generally to a window environment for a computer monitor or other monitor, and more particularly, to actively switching an open window after a period of inactivity.

2. Prior Art

The use of screen saver's is well known in the art. Upon detecting the inactivity of a computer monitor for some predetermined period of time, settable by a user, the screen saver automatically locks the screen. The screen saver generally displays a moving image to preserve the integrity of the monitor, but can also be a blank display. When activity is again detected, e.g., by movement of a mouse or depressing of a key on a keyboard, the screen saver is unlocked and the monitor reverts to the display at the time the screen saver was activated. However, upon unlocking the screen saver, the last used window is still active. Therefore, secret or sensitive information displayed in an active window may be revealed to an unintended viewer.

### SUMMARY OF THE INVENTION

Therefore it is an object of the present invention to provide a method and device for automatically switching an active window after a predetermined period of inactivity such that an unintended viewer cannot view the contents of the active window.

Accordingly, a method for automatically switching a protected window displayed on a monitor is provided where the monitor is connected to a processor which receives external input. The method comprises: detecting a time period of inactivity of the external input; and inactivating the protected window if the time period of inactivity detected is above a predetermined threshold.

Preferably, the method further comprises setting the predetermined threshold by a user.

The inactivating of the protected window preferably comprises minimizing the active window. Alternatively, the inactivating of the protected window comprises closing the protected window. More preferably, the inactivating of the protected window comprises changing the protected window to a default window.

The method preferably further comprises reactivating the inactivated window. The reactivating preferably comprises entering a unique password corresponding to the user.

Also provided is a computer program product embodied in a computer-readable medium for automatically switching a protected window displayed on a monitor where the monitor is connected to a processor which receives external input. The computer program product comprises: computer readable program code means for detecting a time period of inactivity of the external input; and computer readable program code means for inactivating the protected window if the time period of inactivity detected is above a predetermined threshold.

The computer program product preferably further comprises computer readable program code means for setting the predetermined threshold by a user.

Preferably, the computer program product further comprises computer readable program code means for reactivating the inactivated window.

Still provided is a program storage device readable by machine, tangibly embodying a program of instructions executable by the machine to perform method steps for automatically switching a protected window displayed on a monitor where the monitor is connected to a processor which receives external input. The method comprises: detecting a time period of inactivity of the external input; and inactivating the protected window if the time period of inactivity detected is above a predetermined threshold.

Preferably, the inactivating of the protected window comprises minimizing the protected window. Alternatively, the inactivating of the protected window comprises closing the protected window. More preferably, the inactivating of the protected window comprises changing the protected window to a default window.

The method preferably further comprises reactivating the inactivated window.

Still yet provided is an apparatus for automatically switching a protected window displayed on a monitor. The apparatus comprises: a monitor under the control of a processor which receives external input; means for providing instructions to the processor for automatically inactivating the protected window displayed on the monitor after a predetermined time period of inactivity of the external input; means for detecting a time period of inactivity; and means for inactivating the protected window when the time period of inactivity detected is above the predetermined threshold.

The apparatus preferably further comprises means for setting the predetermined threshold by a user.

Preferably, the apparatus further comprises means for reactivating the inactivated window. The means for reactivating preferably comprises means for entering a unique password corresponding to the user.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a preferred implementation of an apparatus for carrying out the methods of the present invention.

FIG. 2a illustrates a display of the monitor of FIG. 1 having a protected active window and an unprotected active window.

FIG. 2b illustrates a display of the monitor of FIG. 1 where the protected active window is inactivated by changing it to a default window.

FIG. 2c illustrates a display of the monitor of FIG. 1 where the protected active window is inactivated by minimizing.

FIG. 2d illustrates a display of the monitor of FIG. 1 where the protected active window is inactivated by closing it.

FIG. 3 illustrates a pop-up window for entering a password on the display of the monitor of FIG. 1.

FIGS. 4, 5a, and 5b illustrate flowcharts showing a preferred implementation of a method of the present invention.

### DETAILED DESCRIPTION OF THE PREFERRED EMBODIMENT

Although this invention is applicable to numerous and various types of windows environments and monitors, it has been found particularly useful in the environment of a windows operating system displayed on a computer monitor. Therefore, without limiting the applicability of the invention to a windows operating system displayed on a computer monitor, the invention will be described in such environment.

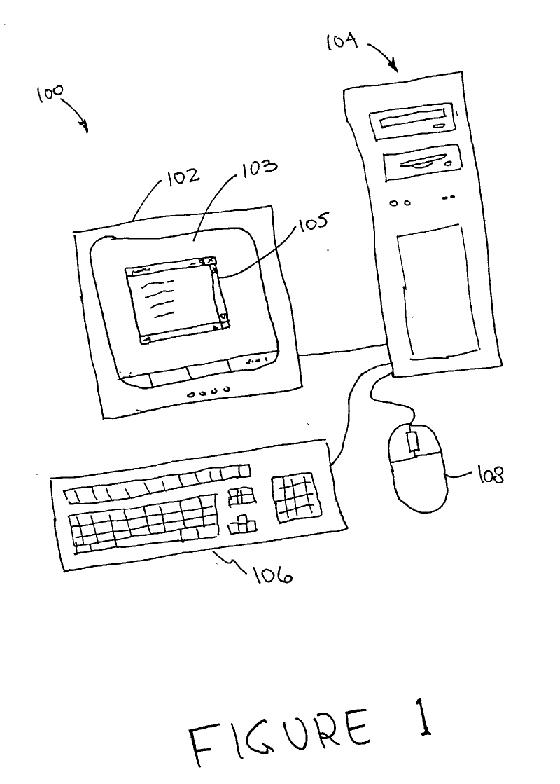

Referring now to FIG. 1, there is illustrated a preferred implementation of an apparatus for automatically switching an active window displayed on a monitor. The apparatus is preferably implemented as a computer system, generally referred to by reference numeral 100. Preferably, the computer system 100 uses a Windows operating system, such as Microsoft Windows 2000. However, other windows environments can be used as well as other systems that utilize a window environment, such as an interactive television.

The computer system 100 has a monitor 102 under the control of a processor 104, which resides in the CPU. The monitor 102 has a display 103, which displays the windows environment including any number of windows 105, at least one of which is active (i.e., currently being worked in). The processor receives various external inputs such as that from a keyboard 106 and mouse 108, each of which are operatively connected to the processor 104 (CPU).

The means for providing the external inputs to the processor 104, for instance, the keyboard 106 and mouse 108, are preferably utilized (along with other functions) to provide instructions to the processor 104 for carrying out the methods of the present invention. For instance, as will be discussed below, the keyboard 106 and mouse 108 can be used to instruct the processor that a certain active window is to be protected (i.e., inactivated after a predetermined period of inactivity), to set the predetermined period of inaction, the inactivation type, whether reactivation requires a password, and entering the password, if required. The user inputs these instructions using techniques well known in the art.

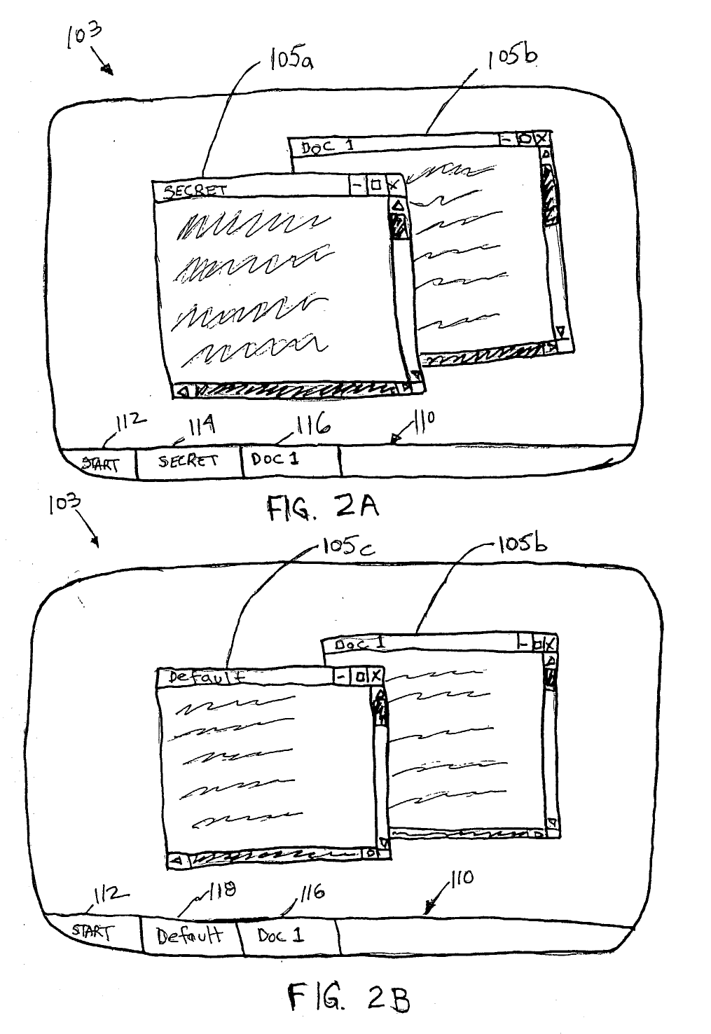

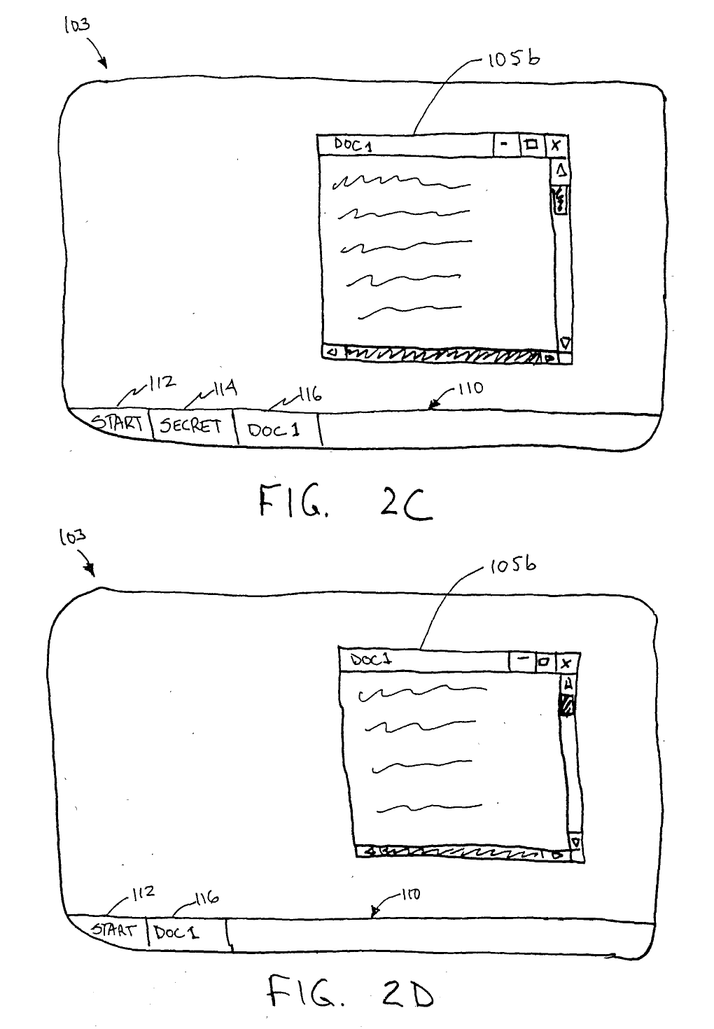

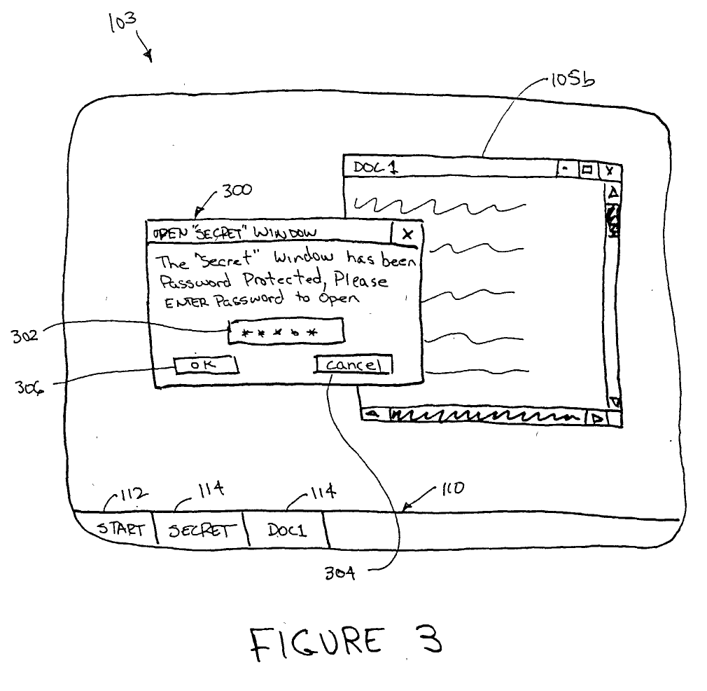

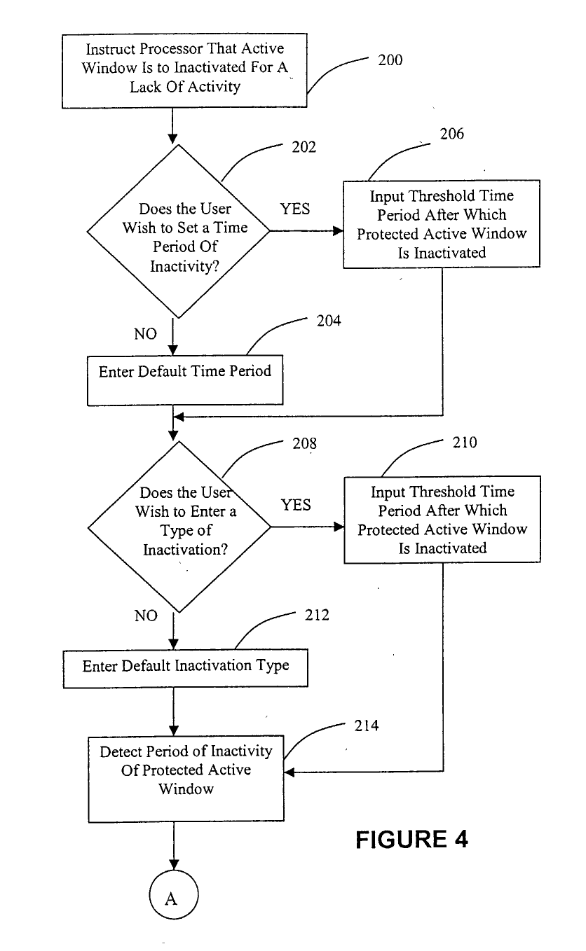

Referring now to FIGS. 2a, 2b, 2c, 2d, 3, 4, 5a, and 5b a method for automatically switching an active window displayed on the monitor 102 will now be described. FIG. 2a illustrates the display 103 having a windows environment and an active window 105a and an inactive window 105b, the active window being labeled “secret” and having secret or sensitive material displayed thereon that the user does not want others to view, the inactive window being labeled “Doc1” and being a text document that the viewer does not care if others view. While the methods of the present invention are illustrated with a single window to be protected, those skilled in the art will appreciate that several such windows can be open at once and all will be protected in the manner chosen (by the user or by default). All such windows will be protected simultaneously when there is a time period of inactivity detected which is above a predetermined threshold period. FIG. 2a also illustrates a status bar 110 having a start button 112, as is known in the-art, as well as buttons 114 and 116 corresponding to the open windows 105a, 105b, respectively.

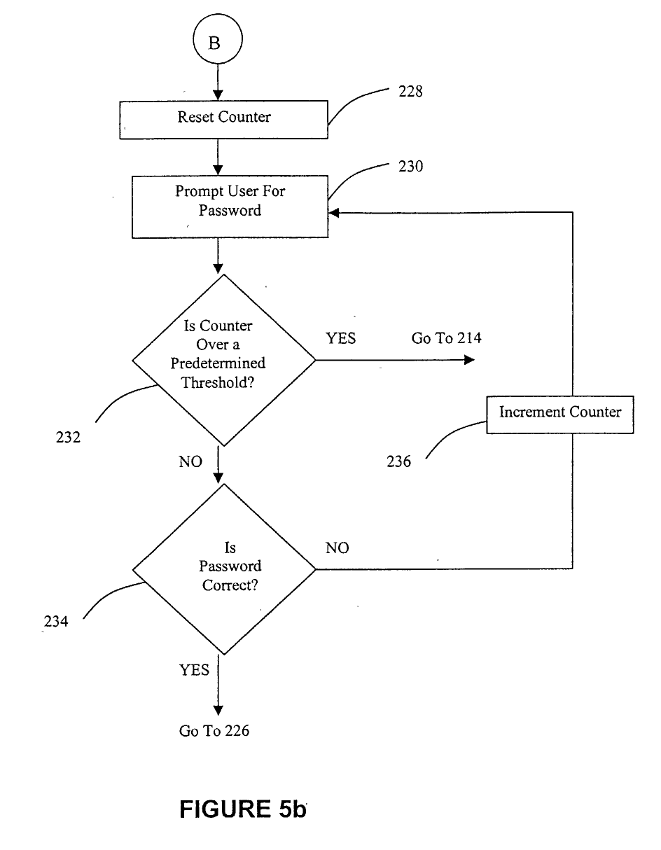

Referring first to FIGS. 4, 5a, and 5b, there is illustrated a flowchart showing the preferred steps in the methods of the present invention. At step 200, the processor 104 is instructed by the user that a certain active window 105a is to be protected, that is, the active window 105a is to be inactivated after a predetermined period of time in which there is no detected activity. At step 202 it is determined if the user wishes to set a predetermined time period after which the active window 105a is inactivated. If the user does not wish to set the predetermined time period, the method proceeds along path 202-NO to step 204 where a default time period is entered. If the user wishes to set the time period, the method proceeds along path 202-YES where the time period is input by the user, preferably by way of the keyboard 106 and/or mouse 108.

Regardless of whether the user sets the time period or a default is used, the method proceeds to step 208, where it is determined if the user wishes to select the type of inactivation for the active window 105. If the user does wish to select the type of inactivation, the method proceeds along path 208-YES to step 210 where the inactivation type is selected by the user, preferably by way of, the keyboard 106 and/or mouse 108. If the user does not wish to enter the inactivation type for the active window 105a, the method proceeds along route 208-NO to step 212 where a default inactivation type is selected.

Examples of the types of inactivation of the active window are illustrated in FIGS. 2b, 2c, and 2d. FIG. 2b shows the active window 105a being changed to a default window 105c after the predetermined time period has elapsed without any activity. The default window can be a dummy window or another working window and can be of any application, such as a web site, a time sheet, or a daily calendar. In the display 103 of FIG. 2b, the status button 118 for the active window 105a is changed to correspond to the default window. FIG. 2c shows the active window 105a being inactivated by being minimized leaving only the inactive window 105b. The status bar 110 of FIG. 2c does not change in this instance, except for a possible change of shading to signify that the window is minimized. Finally, FIG. 2d shows the active window 105a being inactivated by being closed. In this instance, the status button 114 corresponding to the active window 105a is no longer displayed on the status bar 110.

Returning now to FIGS. 4, 5a, and 5b, at step 214 the processor 104 or other dedicated clock connected thereto (not shown) detects a period of inactivity similar to that used when activating a screen saver, as is well known in the art. At step 216 it is determined whether the detected period of inactivity is above the predetermined threshold (either selected by the user or chosen as a default). If the time period of inactivity is not above the predetermined time period, the method proceeds along path 214-NO and loops back to step 214 where the period of inactivity continues to be monitored and detected. If the time period of inactivity is above the predetermined time period, the method proceeds along path 214-YES and the active window is inactivated at step 218 according to the inactivation type selected by the user or chosen by default.

At step 220, activity is detected, such as a movement of the mouse 108 or a pressing of a key on the keyboard 106. A detection of activity for a computer system is well known in the art, such as when a screen saver is inactivated due to activity of a mouse or keyboard. At step 222, it is determined if such an activity is detected. If activity is not detected, the method proceeds along path 222-NO where the method loops back to step 220 and activity continues to be monitored. If activity is detected, the method proceeds along path 222-YES and it is determined if the reactivation of the active window 105a is password protected. If reactivation of the active window 105a does not require a password, the method proceeds along path 224-NO where the active window 105a is reactivated at step 226, generally by allowing the user to again view and work in the window (such as that shown in FIG. 2a).

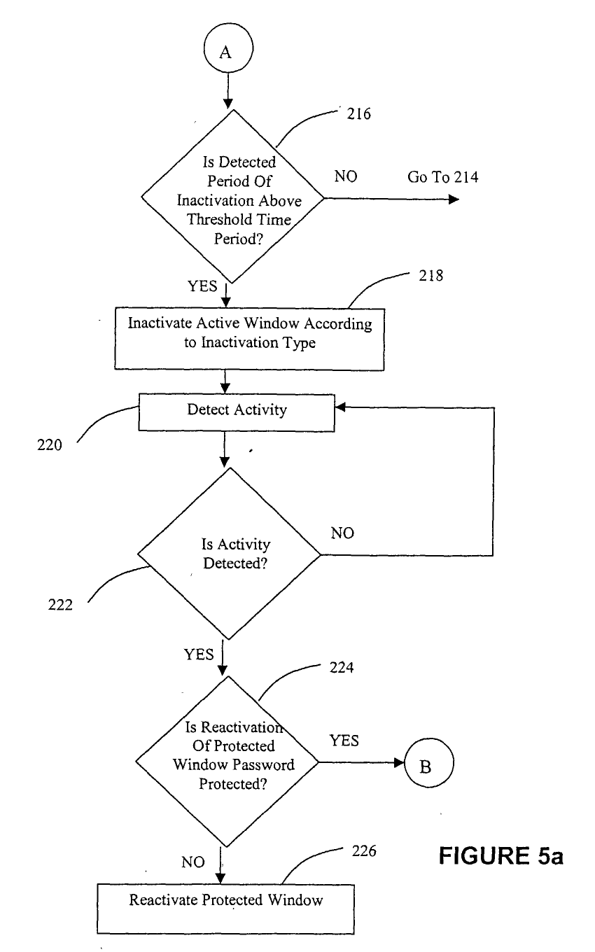

If reactivation of the active window 105a requires entering a password, the method proceeds along path 224-YES to step 228 where a counter is reset or initialized (e.g., to zero). At step 230 the user (or unauthorized third party) is prompted for a password. FIG. 3 illustrates an example of a pop-up window 300 which notifies the user (or unauthorized third party) that reactivation of a previous active window requires entry of a password. The pop-up window 300 includes a field 302 for entry of the password, as well as cancel and OK buttons 304, 306, respectively, as are known in the art. At the time the user indicates that the active window is to be inactivated when there is a time period of inactivity above a predetermined threshold, the user also selects whether reactivation of the active window is to be password protected.

After entering the password in the appropriate field 302, it is determined if the counter is over a predetermined threshold number (i.e., 3). As will be apparent to those skilled in the art, the counter signifies the number of attempts that the password is entered. If the counter is over the threshold number, it is likely that the person entering the password is not the user. Therefore, if the counter is above the threshold number, the method proceeds along path 232-YES to step 214 or otherwise terminated without reactivation of the active window 105a. If the counter is not above the threshold number, the method proceeds along path 232-NO to step 234 where it is determined if the password has been entered correctly. If the password has not been entered correctly, the method proceeds along path 234-NO to step 236 where the counter is incremented (e.g., by one) and then back to step 236 where the user is again prompted for the password. If the password is correctly entered, the method proceeds along path 234-YES to step 226 where the active window 105a is reactivated.

Although, the present method refers to the “secret” window as being “active”, those skilled in the art will appreciate that it may also be in the background (not currently being worked in) and still be inactivated after a period of inactivity that exceeds the predetermined threshold.

### EXAMPLE 1

User A works on very sensitive information contained in the active window 105a. User A instructs the system 100 that he wants the active window 105a minimized after a time period of inactivity greater than two minutes and that reactivation requires a password of 12345. User A receives a call from his colleague to show a demo to a visitor from the competing company. User A leaves his computer to pick up the visitor from the lobby, and when he returns after five minutes, a screen saver is visible on the monitor 102. When User A moves the mouse 108, the screen saver closes and the active window 105a has been minimized such that the sensitive information is not visible. User A then clicks on the status button 114 corresponding to the active window 105a and a pop-up window 300 is displayed prompting User A for a password. User A enters a password of 12345 in field 302 and clicks the OK button 306. The active window 105a is then reactivated.

### EXAMPLE 2

User B works on very sensitive information contained in the active window 105a. User B instructs the system 100 that he wants the active window 105a to change to a default window after a time period of inactivity greater than two minutes and that reactivation requires a password of 12345. User B also supplies a path to display a daily calendar in the default window. User B leaves the building when an emergency siren goes off. User B leaves the building and returns after twenty minutes, a screen saver is visible on the monitor 102. When User B moves the mouse 108, the screen saver closes and the active window 105a has been replaced with a default window showing the daily calendar. User B then clicks on the status button 118 corresponding to the default window 105c and a pop-up window 300 is displayed prompting User B for a password. User B enters a password of 12345 in field 302 and clicks the OK button 306. The default window 105c is then replaced by the active window 105a.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for automatically switching a protected window displayed on a monitor, the monitor being connected to a processor which receives external input, the method comprising:
detecting a time period of inactivity of the external input; and
inactivating the protected window if the time period of inactivity detected is above a predetermined threshold.

2. The method of claim 1, further comprising setting the predetermined threshold by a user.

3. The method of claim 1, wherein the inactivating comprises minimizing the protected window.

4. The method of claim 1, wherein the inactivating comprises closing the protected window.

5. The method of claim 1, wherein the inactivating comprises changing the protected window to a default window.

6. The method of claim 1, further comprising reactivating the inactivated window.

7. The method of claim 6, wherein the reactivating comprises entering a unique password corresponding to the user.

8. A computer program product embodied in a computer-readable medium for automatically switching a protected window displayed on a monitor, the monitor being connected to a processor which receives external input, the computer program product comprising:
computer readable program code means for detecting a time period of inactivity of the external input; and
computer readable program code means for inactivating the protected window if the time period of inactivity detected is above a predetermined threshold.

9. The computer program product of claim 8, further comprising computer readable program code means for setting the predetermined threshold by a user.

10. The computer program product of claim 8, further comprising computer readable program code means for reactivating the inactivated window.

11. A program storage device readable by machine, tangibly embodying a program of instructions executable by the machine to perform method steps for automatically switching a protected window displayed on a monitor, the monitor being connected to a processor which receives external input, the method comprising:
detecting a time period of inactivity of the external input; and
inactivating the protected window if the time period of inactivity detected is above a predetermined threshold.

12. The program storage device of claim 11, wherein the inactivating comprises minimizing the protected window.

13. The program storage device of claim 11, wherein the inactivating comprises closing the protected window.

14. The program storage device of claim 11, wherein the inactivating comprises changing the protected window to a default window.

15. The program storage device of claim 1, wherein the method further comprising reactivating the inactivated window.

16. An apparatus for automatically switching a protected window displayed on a monitor, the apparatus comprising:
a monitor under the control of a processor which receives external input;
means for providing instructions to the processor for automatically inactivating the protected window displayed on the monitor after a predetermined time period of inactivity of the external input;
means for detecting a time period of inactivity; and
means for inactivating the protected window when the time period of inactivity detected is above the predetermined threshold.

17. The apparatus of claim 16, further comprising means for setting the predetermined threshold by a user.

18. The apparatus of claim 16, further comprising means for reactivating the inactivated window.

19. The apparatus of claim 18, wherein the means for reactivating comprises means for entering a unique password corresponding to the user.
